(19) United States
(12) Patent Application Publication
(10) Pub. No.: US 2023/0413908 A1
(43) Pub. Date: Dec. 28, 2023

(54) HEATING ELEMENT, VAPORIZER, AND ELECTRONIC VAPORIZATION DEVICE

(71) Applicant: SHENZHEN SMOORE TECHNOLOGY LIMITED, Shenzhen (CN)

(72) Inventors: Hao LIN, Shenzhen (CN); Junjie TANG, Shenzhen (CN); Libo WANG, Shenzhen (CN); Hongliang LUO, Shenzhen (CN); Congwen XIAO, Shenzhen (CN)

(21) Appl. No.: 18/328,276

(22) Filed: Jun. 2, 2023

(30) Foreign Application Priority Data
Jun. 24, 2022 (CN) 202210725430.4

(51) Int. Cl. A24F 40/46; A24F 40/10; H05B 3/22

(52) U.S. Cl. CPC A24F 40/46; A24F 40/10; H05B 3/22

(57) ABSTRACT

A heating element includes: a porous substrate; and a heating film having a first sub-film and a second sub-film stacked together, the first sub-film being located on a surface of the porous substrate and having a porous structure, the second sub-film being arranged on a side of the first sub-film away from the porous substrate. The second sub-film has a porous structure and a porosity of the second sub-film is less than a porosity of the first sub-film, or the second sub-film has a non-porous structure.

### CROSS-REFERENCE TO PRIOR APPLICATION

Priority is claimed to Chinese Patent Application No. 202210725430.4, filed on Jun. 24, 2022, the entire disclosure of which is hereby incorporated by reference herein.

### FIELD

The present invention relates to the field of vaporizers, and in particular, to a heating element, a vaporizer, and an electronic vaporization device.

### BACKGROUND

A heating element includes a porous ceramic substrate and a heating film. The heating film is generally a solid metal film. A liquid vaporizable substrate can only infiltrate the heating film from the porous ceramic surface adjacent to the heating film. It is difficult for the vaporizable substrate to completely infiltrate the heating film, and the vaporizable substrate cannot be supplied in a timely manner during vaporization, which easily leads to dry heating, resulting in burnout of the heating film and reduced vapor output. Solution to the foregoing problems in the prior art generally adopt a porous heating film, which uses a metal film of a porous structure to generate heat, enabling the heating film to have a certain liquid guide and liquid storage capacity. However, the porous film leads to high resistance of the heating film, resulting in low practical applicability.

### SUMMARY

In an embodiment, the present invention provides a heating element, comprising: a porous substrate; and a heating film comprising a first sub-film and a second sub-film stacked together, the first sub-film being located on a surface of the porous substrate and comprising a porous structure, the second sub-film being arranged on a side of the first sub-film away from the porous substrate, wherein the second sub-film comprises a porous structure and a porosity of the second sub-film is less than a porosity of the first sub-film, or the second sub-film comprises a non-porous structure.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 is a schematic structural diagram of a heating element according to an embodiment;

FIG. 2 is a cross-sectional view of the heating element shown in FIG. 1;

FIG. 3 is a real photo of the heating element shown in FIG. 1.

FIG. 4 is a cross-sectional view of the heating element shown in FIG. 3 after soaking with a substrate to be vaporized;

FIG. 5 is a top view of the heating element shown in FIG. 3 after soaking with a substrate to be vaporized;

FIG. 6 is another schematic structural diagram of a heating film in the heating element shown in FIG. 1; and

FIG. 7 is still another schematic structural diagram of a heating film in the heating element shown in FIG. 1.

### DETAILED DESCRIPTION

In an embodiment, the present invention provides a heating element with low resistance, which can provide a sufficient amount of vaporizable substrate during vaporization to avoid dry heating.

In an embodiment, the present invention provides a vaporizer and an electronic vaporization device including the heating element.

In an embodiment, the present invention provides a heating element, including: a porous substrate and a heating film,
where the heating film includes a first sub-film and a second sub-film stacked together,
the first sub-film is located on the surface of the porous substrate and is of a porous structure;
the second sub-film is arranged on the side of the first sub-film away from the porous
substrate;
the second sub-film is of a porous structure, and the porosity of the second sub-film is
less than the porosity of the first sub-film; or the second sub-film is of a non-porous structure.

In an embodiment, the porosity of the first sub-film ranges from 3% to 80%; and/or,
the average pore size of the first sub-film ranges from 0.1 mm to 5 mm; and/or,
the thickness of the first sub-film ranges from 40 μm to 1000 μm.

In an embodiment, the second sub-film is of a porous structure, and the porosity of the second sub-film is less than or equal to 20%; and/or,
the second sub-film is of a porous structure, and the average pore size of the second sub-film ranges from 0.1 mm to 1 mm; and/or,
the thickness of the second sub-film ranges from 2 μm to 50 μm; and/or,
the thickness of the second sub-film is less than the thickness of the first sub-film.

In an embodiment, the heating film further includes a third sub-film, the third sub-film is arranged between the first sub-film and the second sub-film and is of a porous structure, the porosity of the first sub-film is greater than or equal to the porosity of the third sub-film, and the porosity of the third sub-film is greater than or equal to the porosity of the second sub-film.

In an embodiment, a plurality of third sub-films are provided; the plurality of third sub-films are stacked in sequence between the first sub-film and the second sub-film, and in a direction gradually away from the porous substrate, the porosity of a previous third sub-film is greater than or equal to the porosity of a next third sub-film next to the previous third sub-film.

In an embodiment, the first sub-film and the second sub-film are each independently a metal film or an alloy film.

In an embodiment, the first sub-film and the second sub-film are each independently selected from one of a nickel film, a titanium film, a nickel-iron alloy film, a nickel-copper alloy film, a nickel-chromium alloy film, and an iron-chromium alloy film.

In an embodiment, the shape of the first sub-film is linear, curved, zigzag, rectangular, grid, or annular; and/or,
the positive projection of the second sub-film on the first sub-film falls within the first sub-film.

In an embodiment, at least part of pores of the porous substrate are in communication with pores of the first sub-film; and/or,
the porous substrate is a porous ceramic substrate; and/or,
the porosity of the porous substrate ranges from 25% to 75%; and/or,
the average pore size of the porous substrate ranges from 5 μm to 40 μm.

In an embodiment, the porous substrate is at least one of porous alumina ceramic, porous silica ceramic, porous silicon carbide ceramic, porous cordierite ceramic, porous mullite ceramic, porous sepiolite ceramic, and porous diatomite ceramic.

A vaporizer is provided, including a liquid storage container and the heating element, where the liquid storage container is configured to store a substrate to be vaporized, and the heating element is configured to heat and vaporize the substrate to be vaporized in the liquid storage container.

An electronic vaporization device is provided, including a power supply component and the vaporizer, where the power supply component is configured to supply power to the vaporizer.

The heating element includes the porous substrate and the heating film. The porous substrate is configured to guide a liquid substrate to be vaporized, and the heating film is configured to heat and vaporize the substrate to be vaporized. The heating film includes the first sub-film and the second sub-film stacked together. The first sub-film is located on the surface of the porous substrate and is of a porous structure, which can adsorb the substrate to be vaporized from the surface of the substrate to the heating film by capillary action, to ensure the sufficient supply of liquid, achieve low-temperature vaporization, and avoid dry heating during vaporization. In addition, the inventor has found that when the heating film includes only the first sub-film, the resistance of the heating film is high, resulting in low practical applicability. Therefore, the low-porosity or non-porous second sub-film is stacked on the first sub-film, to reduce the resistance while ensuring the sufficient supply of liquid and a good vaporization effect, so that the heating element can be practically applied.

For ease of understanding the present invention, the present invention will be described below in more detail in the Detailed Description section. Preferred embodiments of the present invention are given in the Detailed Description section. However, the present invention may be implemented in various different forms, and is not limited to the embodiments described in this specification. On the contrary, the embodiments are provided for purpose of providing a more comprehensive understanding of the disclosure of the present invention.

Unless otherwise defined, meanings of all technical and scientific terms used in the present invention are the same as those usually understood by a person skilled in the technical field to which the present invention belongs. In the present invention, terms used in the specification of the present invention are merely used for describing objectives of the specific embodiments, but are not intended to limit the present invention.

The term “and/or” used in the present invention includes any or all combinations of one or more associated listed items.

The terms such as “first”, “second”, and “third” are merely used for purpose of description, and shall not be understood as indicating or implying relative importance or implicitly indicating the number of indicated technical features. Therefore, features defining “first”, “second”, and “third” can explicitly or implicitly include at least one said feature.

In the descriptions of the present invention, unless explicitly specified, “a plurality of” means at least two, for example, two or three.

When a range of values is disclosed in the specification, the range is considered continuous and includes the minimum and maximum values of the range, and every value between the minimum and maximum values. Further, when the range refers to an integer, every integer between the minimum and maximum values of the range is included. In addition, when a plurality of ranges are provided to describe a feature or characteristic, the ranges can be combined. In other words, unless otherwise indicated, all ranges disclosed herein shall be understood to include any and all sub-ranges thereof.

“Embodiment” mentioned in the specification means that particular features, structures, or characteristics described with reference to the embodiment may be included in at least one embodiment of the present invention. The term appearing at different positions of this specification may not refer to the same embodiment or an independent or alternative embodiment that is mutually exclusive with another embodiment. It can be explicitly or implicitly understood by a person skilled in the art that the embodiments described in the specification may be combined with other embodiments.

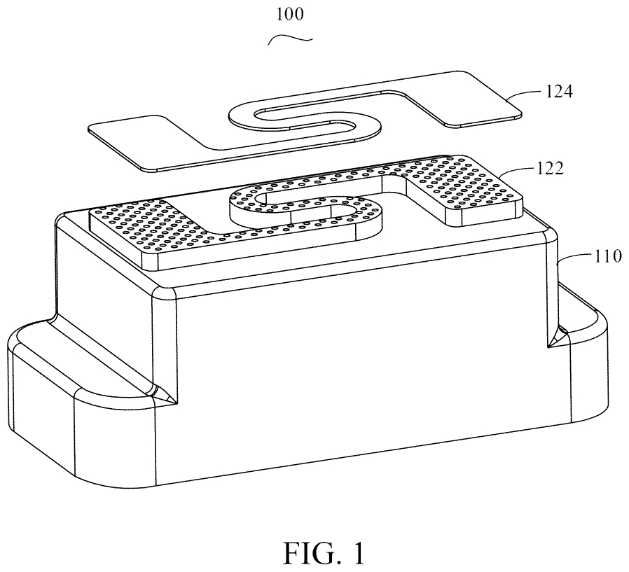

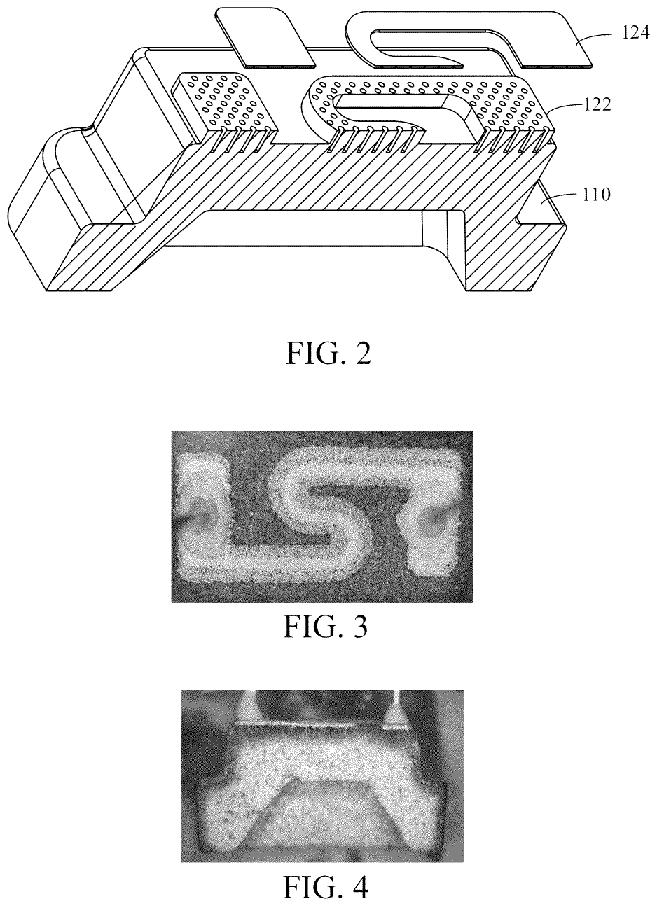

Referring to FIG. 1 and FIG. 2, a first aspect of the present invention provides a heating element 100 of an embodiment, including a porous substrate 110 and a heating film 120. The porous substrate 110 is configured to guide a liquid substrate to be vaporized, and the heating film 120 is configured to heat and vaporize the substrate to be vaporized. The heating film 120 is arranged on the surface of the porous substrate 110.

The heating film 120 includes a first sub-film 122 and a second sub-film 124 stacked together. The first sub-film 122 is located on the surface of the porous substrate 110 and is of a porous structure.

The second sub-film 124 is stacked on the side of the first sub-film 122 away from the porous substrate 110. In some embodiments, the second sub-film 124 is of a porous structure, and the porosity of the second sub-film 124 is less than the porosity of the first sub-film 122. In some other embodiments, the first sub-film 122 is of a porous structure, and the second sub-film 124 is of a non-porous structure.

Specifically, the porosity of the first sub-film 122 ranges from 3% to 80%. In a specific example, the porosity of the first sub-film 122 is 3%, 5%, 10%, 15%, 20%, 25%, 30%, 35%, 40%, 45%, 50%, 55%, 60%, 65%, 70%, 75%, 80%, or a range between any two of these values. Further, the porosity of the first sub-film 122 ranges from 5% to 30%.

The average pore size of the first sub-film 122 ranges from 0.1 mm to 5 mm. In a specific example, the average pore size of the first sub-film 122 is 0.1 mm, 0.5 mm, 1 mm, 1.5 mm, 2 mm, 2.5 mm, 3 mm, 3.5 mm, 4 mm, 4.5 mm, 5 mm, or a range between any two of these values. Further, the average pore size of the first sub-film 122 ranges from 0.5 mm to 2 mm.

The thickness of the first sub-film 122 ranges from 40 μm to 1000 μm. In a specific example, the thickness of the first sub-film 122 is 40 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, 950 μm, 1000 μm, or a range between any two of these values. Further, the thickness of the first sub-film 122 ranges from 60 μm to 400 μm.

Specifically, pores on the first sub-film 122 may be through holes or thick film pores. In some embodiments, the pores on the first sub-film 122 are the through holes, and at least part of the pores on the first sub-film 122 run through the first sub-film 122 along a thickness direction of the first sub-film 122. In this case, the first sub-film 122 may be a steel mesh film. In some other embodiments, the pores on the first sub-film 122 may be thick film pores. In this case, the first sub-film 122 may be a silk screen thick film. It may be understood that, the through holes in the present invention are through holes formed on a metal thin material by laser drilling, etching, stamping, and the like of processes on the metal thin material. The pore size and shape of the through holes are highly consistent. The thick film pores in the present invention are irregular porous structures formed in a thick film. Such structures are irregular porous structures formed in the thick film by adding a certain proportion of a pore-forming agent to a raw material slurry followed by sintering in the process of preparing the thick film.

In some embodiments, the first sub-film 122 has thick film pores. The pore-forming agent used in the preparation of the first sub-film 122 is selected from at least one of starch, carbon powder, ammonium bicarbonate, polymethyl methacrylate (PMMA) microspheres, polystyrene (PS) microspheres, limestone, dolomite, sintered zeolite, perlite, and pumice.

In an embodiment, the first sub-film 122 is a metal film or an alloy film. Specifically, the first sub-film 122 is selected from one of a nickel film, a titanium film, a nickel-iron alloy film, a nickel-copper alloy film, a nickel-chromium alloy film, and an iron-chromium alloy film. In a specific example, the first sub-film 122 is selected from one of a porous nickel film, a porous titanium film, a porous nickel-iron alloy film, a porous nickel-copper alloy film, a porous nickel-chromium alloy film and a porous iron-chromium-aluminum alloy film.

The porosity and the average pore size of the first sub-film 122 are suitable for adsorbing the substrate to be vaporized from the ceramic surface to the heating film 120 by capillary action, to ensure the sufficient supply of liquid. In addition, the first sub-film 122 itself may be made of a metal or alloy material with good electrical and thermal conductivity, which can generate or conduct heat to achieve a good vaporization effect, thereby avoiding dry heating during vaporization.

In some embodiments, the second sub-film 124 is of a porous structure, and the porosity of the second sub-film 124 is less than the porosity of the first sub-film 122. Specifically, the porosity of the second sub-film 124 is less than or equal to 20%. In a specific example, the porosity of the second sub-film 124 is 1%, 5%, 10%, 15%, 20%, or a range between any two of these values.

The average pore size of the second sub-film 124 ranges from 0.1 mm to 1 mm. In a specific example, the average pore size of the second sub-film 124 is 0.1 mm, 0.2 mm, 0.3 mm, mm, 0.5 mm, 0.6 mm, 0.7 mm, 0.8 mm, 0.9 mm, 1 mm, or a range between any two of these values.

The thickness of the second sub-film 124 ranges from 2 μm to 50 μm. Further, the thickness of the second sub-film 124 is less than the thickness of the first sub-film 122. In a specific example, the thickness of the second sub-film 124 is 2 μm, 5 μm, 10 μm, 15 μm, 20 μm, 25 μm, 30 μm, 35 μm, 40 μm, 45 μm, 50 μm, or a range between any two of these values.

In an embodiment, the second sub-film 124 has thick film pores. The pore-forming agent used in the preparation of the second sub-film 124 is selected from at least one of starch, carbon powder, ammonium bicarbonate, PMMA microspheres, PS microspheres, limestone, dolomite, sintered zeolite, perlite, and pumice.

In some other embodiments, the second sub-film 124 is of a non-porous structure. That is, the porosity of the second sub-film 124 is 0. When the second sub-film 124 is of a non-porous structure, because the thickness of the second sub-film 124 is very small and the porosity of the first sub-film 122 is high, the substrate to be vaporized can still be well adsorbed from the ceramic surface to the heating film 120 by capillary action, to ensure the sufficient supply of liquid, achieve a good vaporization effect, and avoid dry heating during vaporization.

Specifically, the second sub-film 124 is a metal film or an alloy film. Specifically, the second sub-film 124 is selected from one of a nickel film, a titanium film, a nickel-iron alloy film, a nickel-copper alloy film, a nickel-chromium alloy film, and an iron-chromium alloy film.

It may be understood that, the material of the first sub-film 122 and the material of the second sub-film 124 may be the same or may be different. In addition, the material of the first sub-film 122 and the second sub-film 124 is not limited to metals or alloys, but may also be other materials that can heat and vaporize the substrate to be vaporized, for example, conductive ceramic, as long as the porosity, the average pore size, and other parameters of the first sub-film 122 and the second sub-film 124 meet the foregoing requirements.

The arrangement of the low-porosity or non-porous second sub-film 124 can reduce the resistance while ensuring the sufficient supply of liquid and a good vaporization effect. Experiments have proved that, when including only the first sub-film 122, the heating film 120 has a resistance ranging from 2Ω to 3Ω, and cannot match the use of a battery; when including the first sub-film 122 and the second sub-film 124, the heating film 120 has a resistance ranging from 0.8Ω to 1.4Ω, and can meet the usage requirements. In addition, the arrangement of the second sub-film 124 can further reduce liquid explosion. When the heating film 120 includes only the first sub-film 122, the noise created by liquid explosion is 70 dB. When the heating film 120 includes the first sub-film 122 and the second sub-film 124, the noise created by liquid explosion is significantly reduced.

In some embodiments, the porosity of the first sub-film 122 ranges from 3% to 80%, and the average pore size of the first sub-film 122 ranges from 0.1 mm to 5 mm. The porosity of the second sub-film 124 is less than or equal to 20%, and the average pore size of the second sub-film 124 ranges from 0.1 mm to 1 mm. The porosity of the first sub-film 122 is greater than the porosity of the second sub-film 124.

The inventor has found through analysis that the first sub-film 122 and the second sub-film 124 having different porosities also have different resistance characteristics, thereby achieving a good match between the heating film 120 and the battery. In addition, because the porosity of the first sub-film 122 is greater than the porosity of the second sub-film 124, the amount of liquid stored in the first sub-film 122 is greater than the amount of liquid stored in the second sub-film 124. Therefore, in the vaporization process, the second sub-film 124 on the outer side which stores less liquid can quickly heat and vaporize the stored liquid under the same heating power, to prevent the formation of a thicker liquid film on the surface of the second sub-film 124, thereby preventing the breakage of the thick liquid film during vaporization to cause liquid explosion. In addition, because the first sub-film 122 maintains a high porosity, and also has good heat generation and/or heat conduction capacity, thereby ensuring a continuous and reliable liquid supply, and avoiding dry heating caused by lack of liquid during vaporization.

Specifically, the porous substrate 110 is a porous ceramic substrate. The porous ceramic is chemically stable, does not chemically react with the substrate to be vaporized, has high-temperature resistance, and therefore does not deform due to an excessively high heating temperature. Therefore, in this embodiment, the porous substrate 110 is preferably the porous ceramic substrate. It may be understood that, the porous substrate 110 is not limited to the porous ceramic, but may also be other porous materials. For example, the porous substrate 110 may also be a porous glass substrate, a porous plastic substrate, a porous metal substrate, or the like.

In an embodiment, the porous substrate 110 is at least one of porous alumina ceramic, porous silica ceramic, porous silicon carbide ceramic, porous cordierite ceramic, porous mullite ceramic, porous sepiolite ceramic, and porous diatomite ceramic.

Further, at least part of pores of the porous substrate 110 are in communication with the pores of the first sub-film 122. By such an arrangement, the substrate to be vaporized can be well guided to the first sub-film 122.

Specifically, the porosity of porous substrate 110 ranges from 25% to 75%. In a specific example, the porosity of the porous substrate 110 is 25%, 30%, 35%, 40%, 45%, 50%, 55%, 60%, 65%, 70%, 75%, or a range between any two of these values. The porosity of porous substrate 110 may also be adjusted based on the composition of the substrate to be vaporized. For example, when the viscosity of the substrate to be vaporized is large, a higher porosity is selected to ensure a good liquid guide effect.

The average pore size of the porous substrate 110 ranges from 5 μm to 40 μm. In a specific example, the average pore size of the porous substrate 110 is 5 μm, 10 μm, 15 μm, 20 μm, 25 μm, 30 μm, 35 μm, 40 μm, or a range between any two of these values.

The porous substrate 110 of the foregoing pore size and porosity provides a uniform liquid guide effect and a good vaporization effect.

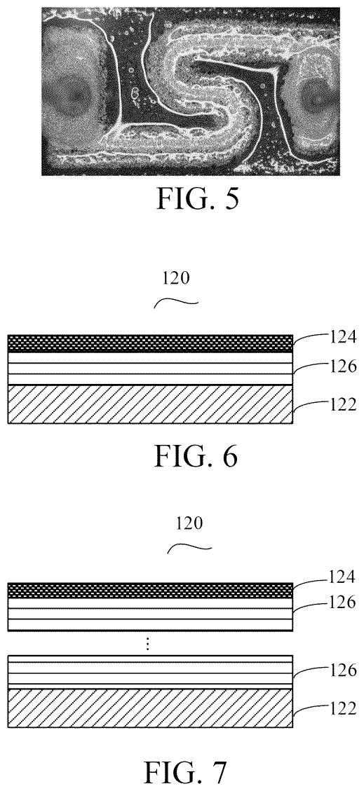

Referring to FIG. 3, FIG. 3 is a real photo of the heating element 100 shown in FIG. 1. FIG. 4 is a cross-sectional view of the heating element 100 shown in FIG. 3 after soaking with the substrate to be vaporized. FIG. 5 is a top view of the heating element 100 shown in FIG. 3 after soaking with the substrate to be vaporized.

The foregoing figures only show one schematic diagram of the heating element 100. In the figure, the shapes of the first sub-film 122 and the second sub-film 124 in the heating film 120 are both curved. It may be understood that, in some other embodiments, the shapes of the first sub-film 122 and the second sub-film 124 are not limited to being curved, but may also be linear, zigzag, rectangular, grid, or annular. The specific shape may be adjusted depending on actual requirements.

In some embodiments, the positive projection of the second sub-film 124 on the first sub-film 122 falls within the first sub-film 122. For example, in a specific example, the second sub-film 124 is of exactly the same shape as the first sub-film 122, and the second sub-film 124 completely covers the first sub-film 122.

In another specific example, the area of the second sub-film 124 is smaller than the area of the first sub-film 122, and the second sub-film 124 partially covers the first sub-film 122. Specifically, the second sub-film 124 may be located in the center of the first sub-film 122 or not. When the first sub-film 124 is located in the center of the first sub-film 122, a uniform and reliable liquid supply can be provided, to avoid dry heating. Meanwhile, the resistance is well improved to make the resistance uniform and highly consistent, so as to avoid breakage and failure under thermal shock caused by partial inconsistent resistance due to excessively high local resistance during use. In addition, because the resistivity of the second sub-film 124 is low, the current density of the second sub-film 124 is high, and more heat is generated, the second sub-film 124 located in the center can dissipate heat evenly through the first sub-film 122, making the heat generation or thermal field distribution more uniform, and avoiding dry heating due to local high temperature. Furthermore, the first sub-film 122 can also provide a function of preheating the substrate to be vaporized.

When the second sub-film 124 is not located in the center of the first sub-film 122, the position of the second sub-film 124 can be flexibly arranged based on the heating circuit, and the amounts of heat generated in different areas or the thermal field distribution can be adjusted depending on specific requirements. Therefore, the above effect can be achieved by adjusting the position of the second sub-film 124 without needing to adjust the position of the first sub-film 122

As shown in FIG. 3 and FIG. 5, in this embodiment, the area of the second sub-film 124 is smaller than the area of the first sub-film 122, and the second sub-film 124 partially covers the first sub-film 122. After soaking with the substrate to be vaporized, the thickness of the liquid film on the surface of the heating film 120 is less than the thickness of the liquid film at other positions. That is, the substrate to be vaporized forms a liquid film with a thickness gradient on the vaporization surface of the heating element 100. The liquid film with the thickness gradient can achieve a good vaporization effect and reduce liquid explosion.

In an embodiment, preparation steps of the heating element 100 are as follows: The porous substrate 110 is screen-printed with the first sub-film 122 and the second sub-film 124, and then vacuum sintered.

Specifically, a layer of the first sub-film 122 is screen-printed on the porous substrate 110 by screen printing first, and the second sub-film 124 is printed on the first sub-film 122. The line width of the second sub-film 124 is less than or equal to the line width of the first sub-film 122. In a specific example, the line width of the first sub-film 122 ranges from 0.2 mm to 1 mm. The line width of the second sub-film 124 ranges from 0.2 mm to 1 mm. It may be understood that only one example of the line widths of the first sub-film 122 and the second sub-film 124 is listed above. However, the line widths of the first sub-film 122 and the second sub-film 124 are not limited thereto, and may be adjusted depending on actual situations.

Referring to FIG. 6, in some embodiments, the heating film 120 further includes a third sub-film 126. The third sub-film 126 is arranged between the first sub-film 122 and the second sub-film 124, and is of a porous structure. The porosity of the first sub-film 122 is greater than or equal to the porosity of the third sub-film 126, and the porosity of the third sub-film 126 is greater than or equal to the porosity of the second sub-film 124.

For example, in a specific example, the porosity of the third sub-film 126 is the same as the porosity of the first sub-film 122. In another specific example, the porosity of the third sub-film 126 is the same as the porosity of the second sub-film 124. In another specific example, the porosity of the third sub-film 126 is between the porosity of the first sub-film 122 and the porosity of the second sub-film 124.

Further, referring to FIG. 7, there are a plurality of third sub-films 126. The plurality of third sub-films 126 are stacked in sequence between the first sub-film 122 and the second sub-film 124. In a direction gradually away from the porous substrate 110, the porosity of a previous third sub-film 126 is greater than or equal to the porosity of a next third sub-film 126 next to the previous third sub-film 126. Specifically, in FIG. 7, the direction gradually away from the porous substrate 110 refers to the direction from the bottom to the top.

For example, there are two, three, four, or more third sub-films 126. The plurality of third sub-films 126 may have the same or different porosities, but in the direction gradually away from the porous substrate 110, the porosities of the plurality of third sub-films 126 decrease or remain unchanged. In a specific example, there are two third sub-films 126, and in the direction gradually away from the porous substrate 110, the porosities of the two third sub-films 126 decrease. In another specific example, there are two third sub-films 126, and the porosities of the two third sub-films 126 are the same, and are equal to the porosity of the first sub-film 122 or the porosity of the second sub-film 124 or between the porosity of the first sub-film 122 and the porosity of the second sub-film 124. It may be understood that when there are three, four or more third sub-films 126, the porosities of these third sub-film 126 may be set with reference to the above settings.

Specifically, the third sub-film 126 is a metal film or an alloy film. Specifically, the third sub-film 126 is selected from one of a nickel film, a titanium film, a nickel-iron alloy film, a nickel-copper alloy film, a nickel-chromium alloy film, and an iron-chromium alloy film. In a specific example, the third sub-film 126 is selected from one of a porous nickel film, a porous titanium film, a porous nickel-iron alloy film, a porous nickel-copper alloy film, a porous nickel-chromium alloy film and a porous iron-chromium-aluminum alloy film.

In some embodiments, the third sub-film 126 has the thick film pores. The pore-forming agent used in the preparation of the third sub-film 126 is selected from at least one of starch, carbon powder, ammonium bicarbonate, PMMA microspheres, PS microspheres, limestone, dolomite, sintered zeolite, perlite, and pumice.

It may also be understood that, the material of the third sub-film 126 may be the same as or different from the material of the first sub-film 122 and the second sub-film 124. In addition, the material of the third sub-film 126 is not limited to metals or alloys, but may also be other materials that can heat and vaporize the substrate to be vaporized, for example, conductive ceramic, as long as the porosity of the third sub-film 126 meets the foregoing requirements.

The arrangement of the third sub-film 126 between the first sub-film 122 and the second sub-film 124 can guide the substrate to be vaporized to the heating film 120 by capillary action while increasing the thickness of the heating film 120, to avoid dry heating, thereby withstanding a high-power battery.

When the heating film 120 further includes the third sub-film 126, the positive projection of the third sub-film 126 on the first sub-film 122 falls within the first sub-film 122, and the positive projection of the second sub-film 124 on the third sub-film 126 falls within the third sub-film 126.

In this case, the preparation steps of the heating element 100 are as follows: The porous substrate 110 is screen-printed sequentially with the first sub-film 122, the third sub-film 126 and the second sub-film 124, and then vacuum sintered.

Specifically, first, a layer of the first sub-film 122 is printed on the porous substrate 110 by screen printing. The third sub-film 126 is printed on the first sub-film 122. The line width of the third sub-film 126 is less than or equal to the line width of the first sub-film 122. The second sub-film 124 is printed on the third sub-film 126. The line width of the second sub-film 124 is less than or equal to the line width of the third sub-film 126. In a specific example, the line width of the first sub-film 122 ranges from 0.2 mm to 1 mm. The line width of the third sub-film 126 ranges from 0.2 mm to 1 mm. The line width of the second sub-film 124 ranges from 0.2 mm to 1 mm. It may be understood that only one example of the line widths of the first sub-film 122, the third sub-film 126 and the second sub-film 124 is listed above. However, the line widths of the first sub-film 122, the third sub-film 126, and the second sub-film 124 are not limited thereto, and may be adjusted depending on actual situations.

When there are a plurality of third sub-films 126, in the direction away from the porous substrate 110, the positive projection of a next third sub-film 126 on the previous third sub-film 126 previous to the next third sub-film 126 falls within the previous third sub-film 126. The positive projection of the second sub-film 124 on the last third sub-film 126 falls within the last third sub-film 126.

The heating element 100 of this embodiment has at least the following advantages:
(1) The heating element 100 includes the porous substrate 110 and the heating film 120. The porous substrate 110 is configured to guide the substrate to be vaporized, and the heating film 120 is configured to heat and vaporize the substrate to be vaporized. The heating film 120 includes the first sub-film 122 and the second sub-film 124 stacked together. The first sub-film 122 is located on the surface of the porous substrate 110. The first sub-film 122 can better adsorb the substrate to be vaporized from the ceramic surface to the heating film 120 by capillary action, to ensure the sufficient supply of liquid, achieve low-temperature vaporization, and avoid dry heating during vaporization. In addition, the inventor has found that when the heating film 120 includes only the first sub-film 122, the resistance of the heating film 120 is high, resulting in low practical applicability. Therefore, the low-porosity or non-porous second sub-film 124 is stacked on the first sub-film 122, to reduce the resistance while ensuring the sufficient supply of liquid and a good vaporization effect, so that the heating element 100 can be practically applied.
(2) The second sub-film 124 in the heating element 100 can also reduce liquid explosion. Experiments have proved that, when the heating film 120 includes only the first sub-film 122, the noise created by the liquid explosion is 70 dB; and when the heating film 120 includes the first sub-film 122 and the second sub-film 124, the noise created by the liquid explosion is significantly reduced.
(3) The heating film 120 of the heating element 100 may further include at least one third sub-film 126, which can guide the substrate to be vaporized to the heating film 120 by capillary action while increasing the thickness of the heating film 120, to avoid dry heating, thereby withstanding a high-power battery.

A second aspect of the present invention further provides a vaporizer of an embodiment. The vaporizer includes a liquid storage container and a heating element. The liquid storage container is configured to store a substrate to be vaporized. The heating element is configured to heat and vaporize the substrate to be vaporized in the liquid storage container. The heating element is the heating element of the foregoing embodiments, and the details will not be repeated herein.

The vaporizer may be specifically configured to vaporize the substrate to be vaporized and generate an aerosol for use in different fields, such as medical treatment or electronic aerosol generation devices. In an embodiment, the vaporizer may be used in an electronic aerosol generation device to vaporize the substrate to be vaporized and generate an aerosol for a user to inhale. For example, the vaporizer may be used in an e-cigarette. It may be understood that, in some other embodiments, the vaporizer is not limited thereto, and may also be used in medical equipment for treating diseases of upper and lower respiratory systems to vaporize medical drugs or the like.

The vaporizer ensures the sufficient supply of liquid during vaporization, achieves low-temperature vaporization, and avoid dry heating during vaporization.

A third aspect of the present invention further provides an electronic vaporization device of an embodiment. The electronic vaporization device includes a power supply component and a vaporizer. The power supply component is configured to supply power to the vaporizer. The vaporizer is the vaporizer of the foregoing embodiments, and the details will not be repeated herein. In a specific example, the power supply component may include a battery and a controller. The battery is configured to supply power to the vaporizer. The controller is configured to control operation of the vaporizer.

In an embodiment, the electronic vaporization device may be an e-cigarette.

The electronic vaporization device ensures the sufficient supply of liquid during vaporization, achieves low-temperature vaporization, and avoid dry heating during vaporization.

To make the objectives and advantages of the present invention clearer, the heating element of the present invention and its effects will be described below in further detail through specific embodiments. It should be understood that the specific embodiments described herein are only used for explaining the present invention, and are not be intended to limit the present invention.

### Embodiment 1

This embodiment provides a heating element. The heating element includes a porous substrate and a heating film. The porous substrate is porous cordierite ceramic. The porous substrate has an average pore size ranging from 8 μm to 15 μm, a porosity of 50%, and a thickness of 4 mm. The heating film includes a first sub-film and a second sub-film stacked together. The first sub-film is located on the surface of the porous substrate, is made of a nickel-iron alloy film, and has an average pore size of 1 mm, a porosity of 35%, and a thickness of 500 μm. The second sub-film is arranged on the side of the first sub-film away from the porous substrate, is made of a nickel-iron alloy film, and has an average pore size of 0.2 mm, a porosity of 22%, and a thickness of 30 μm. In this embodiment, the first sub-film and the second sub-film are silk screen thick films. In addition, the porous structures of the first sub-film and the second sub-film are thick film pores.

### Embodiment 2

This embodiment provides a heating element. The heating element includes a porous substrate and a heating film. The porous substrate is porous silica ceramic, and has an average pore size ranging from 20 μm to 25 μm, a porosity of 60%, and a thickness of 3 mm. The heating film includes a first sub-film and a second sub-film stacked together. The first sub-film is located on the surface of the porous substrate, made of a nickel-chromium alloy film, and has an average pore size of 0.5 mm, a porosity of 20%, and a thickness of 150 μm. The second sub-film is arranged on the side of the first sub-film away from the porous substrate, made of a nickel-chromium alloy film, and has an average pore size of 0.2 mm, a porosity of 10%, and a thickness of 10 μm. In this embodiment, pores of the first sub-film all run through the first sub-film along a thickness direction of the first sub-film. The first sub-film is made of a dense metal thin material, on which the pores may be prepared by laser, etching, stamping, and the like. The porous structures of the second sub-film are thick film pores. The second sub-film is prepared on the surface of the first sub-film by silkscreen printing.

### Embodiment 3

This embodiment provides a heating element, which is similar to the structure of the heating element of Embodiment 1 except that the heating film further includes a third sub-film. The third sub-film is arranged between the first sub-film and the second sub-film. The third sub-film is made of iron chromium aluminum, and has an average pore size of 0.1 mm, a porosity of 2%, and a thickness of 5 μm.

### Embodiment 4

This embodiment provides a heating element, which is similar to the structure of the heating element of Embodiment 1 except that the second sub-film is of a non-porous structure.

### Embodiment 5

This embodiment provides a heating element, which is similar to the structure of the heating element of Embodiment 1 except that the porosity of the second sub-film is 5%.

### Comparative Example 1

Comparative Example 1 provides a heating element. The heating element includes a porous substrate and a heating film. The porous substrate is porous silica ceramic, and has an average pore size of 15 μm, a porosity of 60%, and a thickness of 4 mm. The heating film is a non-porous nickel-chromium metal film, having a thickness of 500 μm.

### Comparative Example 2

Comparative Example 2 provides a heating element, which is similar to the structure of the heating element of Embodiment 1 except that the heating film includes only the first sub-film, not the second sub-film.

The heating elements of the foregoing embodiments and comparative examples were tested, and test data shown in Table 1 below was obtained. Dry heating test refers to a quantity of vapes where dry heating occurs during vaping by a machine after a ceramic vaporization core is assembled into a cartridge.

TABLE 1
Test data of embodiments and comparative examples

| | | | Noise of liquid |
|---|---|---|---|
| | Dry heating test | Resistance/Ω | explosion/dB |
| Embodiment 1 | 1200-1500 | 1.4-1.8 | 60-65 |
| Embodiment 2 | 1000-1200 | 1.0-1.4 | 55-60 |
| Embodiment 3 | 1000-1200 | 0.8-1.2 | 40-45 |
| Embodiment 4 | 800-1000 | 0.8-1.2 | 40-45 |
| Embodiment 5 | 800-1000 | 1.0-1.4 | 50-55 |
| Comparative | 200-300 | 0.8-1.2 | 40-45 |
| Example 1 | | | |
| Comparative | 1200-1500 | 1.8-2.4 | 85-95 |
| Example 2 | | | |
| Comparative | 400-600 | 1.4-1.8 | 60-65 |
| Example 3 | | | |

The technical features in the foregoing embodiments may be randomly combined. For the brevity of description, not all possible combinations of the technical features in the embodiments are described. However, provided that combinations of the technical features do not conflict with each other, the combinations of the technical features are considered as falling within the scope set forth in this specification.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A heating element, comprising:
a porous substrate; and
a heating film comprising a first sub-film and a second sub-film stacked together, the first sub-film being located on a surface of the porous substrate and comprising a porous structure, the second sub-film being arranged on a side of the first sub-film away from the porous substrate,
wherein the second sub-film comprises a porous structure and a porosity of the second sub-film is less than a porosity of the first sub-film, or the second sub-film comprises a non-porous structure.

2. The heating element of claim 1, wherein the porosity of the first sub-film ranges from 3% to 80%, and/or
wherein an average pore size of the first sub-film ranges from 0.1 mm to 5 mm, and/or
wherein a thickness of the first sub-film ranges from 40 μm to 1000 μm.

3. The heating element of claim 1, wherein the second sub-film comprises a porous structure, and the porosity of the second sub-film is less than or equal to 20%, and/or,
wherein the second sub-film comprises a porous structure and an average pore size of the second sub-film ranges from 0.1 mm to 1 mm, and/or,
wherein a thickness of the second sub-film ranges from 2 μm to 50 μm, and/or
wherein a thickness of the second sub-film is less than a thickness of the first sub-film.

4. The heating element of claim 1, wherein the heating film comprises at least one third sub-film, the at least one third sub-film being arranged between the first sub-film and the second sub-film and comprising a porous structure,
wherein the porosity of the first sub-film is greater than or equal to a porosity of the at least one third sub-film, and
wherein the porosity of the at least one third sub-film is greater than or equal to the porosity of the second sub-film.

5. The heating element of claim 4, wherein the at least one third sub-film comprises a plurality of third sub-films, and
wherein the plurality of third sub-films are stacked in sequence between the first sub-film and the second sub-film, and in a direction gradually away from the porous substrate, the porosity of a previous third sub-film of the plurality of third sub-films being greater than or equal to a porosity of a next third sub-film of the plurality of third sub-films next to the previous third sub-film.

6. The heating element of claim 5, wherein the first sub-film and the second sub-film each independently comprise a metal film or an alloy film.

7. The heating element of claim 6, wherein the first sub-film and the second sub-film are each independently selected from one of a nickel film, a titanium film, a nickel-iron alloy film, a nickel-copper alloy film, a nickel-chromium alloy film, and an iron-chromium alloy film.

8. The heating element of claim 7, wherein a shape of the first sub-film is linear, curved, zigzag, rectangular, grid, or annular, and/or,
wherein a positive projection of the second sub-film on the first sub-film falls within the first sub-film.

9. The heating element of claim 7, wherein at least part of pores of the porous substrate are in communication with pores of the first sub-film, and/or,
wherein the porous substrate comprises a porous ceramic substrate, and/or
wherein a porosity of the porous substrate ranges from 25% to 75%, and/or
wherein an average pore size of the porous substrate ranges from 5 μm to 40 μm.

10. The heating element of claim 9, wherein the porous substrate comprises at least one of porous alumina ceramic, porous silica ceramic, porous silicon carbide ceramic, porous cordierite ceramic, porous mullite ceramic, porous sepiolite ceramic, and porous diatomite ceramic.

11. A vaporizer, comprising:
a liquid storage container; and
the heating element of claim 1,
wherein the liquid storage container is configured to store a substrate to be vaporized, and
wherein the heating element is configured to heat and vaporize the substrate to be vaporized in the liquid storage container.

12. An electronic vaporization device, comprising:
a power supply component; and
the vaporizer of claim 11,
wherein the power supply component is configured to supply power to the vaporizer.
